(19) United States
(12) Patent Application Publication
(10) Pub. No.: US 2005/0092221 A1
(43) Pub. Date: May 5, 2005

(54) Method of no-till farming

(75) Inventor: Henry J. Bergen, Coaldale (CA)

Correspondence Address: LARRY R. MEENAN, 1146 CHAUCER DRIVE, GREENSBURG, PA, 15601, US

(73) Assignee: GEN MANUFACTURING LTD., Coaldale (CA)

(21) Appl. No.: 10/696,084

(22) Filed: Oct. 29, 2003

(51) Int. Cl. A01C 1/00

(52) U.S. Cl. 111/200

(57) ABSTRACT

A method of no-till fanning within soil. The method includes the steps of providing a darkened stubble; forming a furrow within the soil; and then introducing seed within the furrow whereby the darkened stubble absorbs energy radiation to warm the soil temperature. The darkened stubble is residues of cultivated crops, for example cereal grains. In one embodiment, the darkened stubble is darkened by application of a dark colored pigment. In yet additional alternate embodiments, the darkened stubble is darkened by genetically altering the color of the stubble or by selective plant breeding.

### BACKGROUND OF THE INVENTION

1. Field of the Invention

This invention relates to a method of no-till farming. More particularly, this invention relates to a method of no-till farming wherein darkened stubble and other plant matter is used to promote growth, and development of cultivated plants.

2. Description of the Related Art

The need to till and cultivate soil for the planting of crops has been accomplished since the earliest days of civilization. In conventional farming, the soil is tilled after the crop is harvested in the fall in order to break up the roots and stalks left in the field, and several times more before planting of the next crop to provide loose soil for receiving the seed. More recently, there has been an increased emphasis on conserving natural resources resulting in these concerns being integrated in modern tillage systems.

Minimum till and no till farming encourages tilling, planting and fertilizing in a single pass of the tillage device or cultivator through the field. Unless expressly indicated otherwise, as used herein, minimum till and no-till farming techniques are collectively referred to as no-till farming techniques.

In the no-till farming technique the soil is disturbed only along the slit or hole into which seeds are planted. The stubble remains from previous crops and covers and protects the seedbed. No-till farming techniques seek to minimize the number of tillings in order to save on fuel costs for machinery, extend the life of machines, enable larger acreage to be tilled and save on labor costs by allowing the same or smaller work force. Less tillage minimizes soil erosion and pollution of water in wells, aquifers and waterways. Less tillage reduces the runoff of plant nutrients, unused commercial fertilizers, and herbicide residues. No till farming techniques, in particular, are believed to improve moisture retention in the soil aiding future crops because the residue left on the ground with these techniques acts as mulch. The composting effect of the stubble and other plant matter such as leaves and root material after it has decomposed may in the long term reduce the need for commercial fertilizer. No-till farming techniques are encouraged or required on some acreage by laws and regulations.

A number of different films and coatings are known for use in agriculture as a covering for surfaces such as fields, in order to obtain special conditions for plant growth. Best known are various types of dark plastic films as covers, in order to obtain higher temperatures in the earth under the film and thereby an increased crop yield.

The present invention is directed to a method of no-till farming in which stubble and other plant matter comprising dark colored detritus or straw is used to increase the temperature of the soil to prolong the planting season and promote germination and growth, and the development of cultivated plants. The rays striking the earth supply the earth's surface with energy and the majority of the energy is converted to heat in the ground. Energy radiation is absorbed by the dark colored stubble and other plant matter and is converted to heat in the ground. Energy radiation refers to all types of radiation striking the surface of the earth such as radio waves, infrared rays, visible light, ultraviolet rays, X-rays, gamma rays and cosmic rays.

### SUMMARY OF THE INVENTION

Briefly, according to this invention, there is provided a method of no-till farming within soil. The method includes the steps of providing a darkened stubble and other plant matter; forming a furrow within the soil; and then introducing seed within the furrow whereby the darkened stubble and other plant matter absorbs energy radiation to warm the soil temperature. The term “darkened” refers to a change in the color of the cultivated crop from the naturally occurring color to a more darker hue that that heretofore naturally occurring for the cultivated crop. The darkened stubble is residues of cultivated crops such as cereal grains or other cultivated crops, for example, flax and canola grains. In one embodiment, the residues of cereal grain are selected from the group consisting of wheat, barley, oats and rice. In one embodiment, the darkened stubble and other plant matter is darkened by application of a dark colored pigment. In alternate embodiment of the present invention, the darkened stubble and other plant matter may be darkened by genetically altering the color of the cultivated plant or by selective plant breeding.

### DESCRIPTION OF THE PREFERRED EMBODIMENT

In typical no-till farming, the farmer eliminates the step of tilling the stubble and other plant matter left from a harvested crop prior to the planting of a new crop. The new crop is planted directly into the standing stubble and other plant matter. The root channels allow water to penetrate into the soil and the stubble and other plant matter is effective in holding moisture in the soil regardless of the condition of the terrain and. Because of its water retention capabilities, the stubble and other plant matter greatly reduces the amount of surface water runoff from a field area. In addition, the stubble and other plant matter also greatly reduces the loss of topsoil through the eroding action of wind and water runoff. It also reduces the amount of herbicide and fertilizer losses which are normally caused by wind and water runoff from a field area.

In accordance with a preferred embodiment of the present invention the stubble and other plant matter is darkened to enhance the absorption of the energy radiation from the sun. In a preferred embodiment, the darkened stubble and other plant matter comprises residues of cultivated crops such as cereal grains (wheat, barley, oats, rice, etc.). The darkened stubble and other plant matter forms a crust with the soil and/or a layer over it, through which seeds can emerge and later grow through the stubble and other plant matter. The layer of darkened stubble and other plant matter formed on the soil can serve to increase soil temperature, confer a color to the soil, maintain soil structure, prevent erosion, reduce evaporation and fasten plants growth. The darkened stubble and other plant matter offers advantages such as keeping the soil warm by retaining heat absorbed from the sun, thereby promoting accelerated seed germination. The darkened stubble and other plant matter causes the underlying soil to absorb more energy to warm the soil. This will permit the planting of crops in seasons or under conditions where the soil temperature would typically be too cool for good plant growth.

It will be appreciated that the nature and type of darkened stubble and other plant matter will be adapted to suit the climate, the area where the no-till farming technique is applied and the surface and the nature of the soil. The soil's content of humus and other materials can be measured by standard measuring methods, thus providing an indication of the nutrient content and regulating materials which the layer of darkened stubble and other plant matter has to contain and the amount and thickness of the stubble and other plant matter which it will be necessary to apply on the area concerned. For example, in areas where the soil contains very little humus, it may be necessary to add additional regulating materials.

The stubble and other plant matter may be darkened using most any suitable technique well known in the art. For example, the stubble and other plant matter may be darkened by application of a dark colored pigment. In an alternative embodiment, the stubble and other plant matter may be darkened by genetically altering the color of the cultivated crop to a darker color. Such techniques for gene transformation of plant species may include, but are not limited to transformation vector, agroinfection, electroinjection, and particle bombardment with a gene gun or microinjection. The darkened stubble and other plant matter may also be formed by using selective plant breeding techniques well known in the art.

In operation, a suitable distribution system supplied seed and fertilizer and optional other agricultural chemicals into a furrow formed in the ground which has not been recently tilled. The darkened stubble and other plant matter from the previous crop has not been removed from the field. The surface of the soil is opened in a localized area so that the seed, fertilizer, and other agricultural chemicals can be placed directly into the furrow formed in the soil. When disk type soil openers are used, it is necessary for the disk to penetrate into the soil to open a furrow into which the seed or other materials can be placed. Because the field has generally not been cultivated the disk soil openers must penetrate the debris for engaging the topsoil, and laterally directing the darkened stubble and other plant matter and soil away from the furrow being formed. The darkened stubble and other plant matter is scraped clear of the furrow and localized adjacent thereto. The darkened stubble and other plant matter helps the soil to retain moisture adjacent the furrows. Additionally, the stubble and other plant matter absorbs solar radiation and prevents exposure of the furrows to extreme temperatures and wind. Further, the darkened stubble and other plant matter results in the stubble and other plant matter feeding upon itself creating more organic life and corresponding nutrients for the soil.

The invention will be further clarified by a consideration of the following example, which is intended to be purely exemplary of the invention.

### EXAMPLE

A 30 feet by 330 feet area of triticate stubble was covered with black latex paint after seeding green peas. Temperature probes were placed approximately 5 cm. below the soil surface. Black latex paint was then sprayed on some of the stubble.

The temperature probes in the painted and unpainted stubble were placed 5 meters apart. The north and south temperature probes were placed 10 meters apart. The soil temperature was measured and plant counts were taken. The temperature was then compared between the painted and unpainted stubble. The results are reported in Table 1.

TABLE 1
Average temperature in degrees Celsius for entire time period

| Location | Stubble | Painted | Difference |
|---|---|---|---|
| South | 15.7 | 16.9 | 1.3 |
| North | 16.2 | 17.1 | 0.9 |

As shown in the table, the average temperature of the soil using darkened stubble increased about 1.1 degrees Celsius as compared to the use of nondarkened stubble.

The documents, patents and patent applications referred to herein are hereby incorporated by reference.

While the invention has been specifically described in connection with certain specific embodiments thereof, it is to be understood that this is by way of illustration and not of limitation, and the scope of the appended claims should be construed as broadly as the prior art will permit.

1. A method of no-till farming within soil, the method comprising the steps of:
providing a darkened stubble of a cultivated crop;
forming a furrow within the soil;
and introducing seed within the furrow whereby the darkened stubble absorbs energy radiation to warm the soil temperature.

2. The method of claim 1 wherein the darkened stubble is residues of cultivated crops.

3. The method of claim 2 wherein the cultivated crops are cereal grains.

4. The method of claim 3 wherein the residues of cereal grain are selected from the group consisting of wheat, barley, oats and rice.

5. The method of claim 1 wherein the darkened stubble is darkened by application of a dark colored pigment.

6. The method of claim 1 wherein the darkened stubble is darkened by genetically altering the color of the stubble.

7. A method of no-till farming comprising providing a darkened stubble of a cultivated crop.

8. The method of claim 7 wherein the darkened stubble is residues of cultivated crops.

9. The method of claim 7 wherein the darkened stubble is residues of cereal grains.

10. The method of claim 9 wherein the residues of cereal grain are selected from the group consisting of wheat, barley, oats and rice.

11. The method of claim 7 wherein the darkened stubble is darkened by application of a dark colored pigment.

12. The method of claim 7 wherein the darkened stubble is darkened by genetically altering the color of the stubble.
